(19) United States
(12) Patent Application Publication
(10) Pub. No.: US 2007/0109438 A1
(43) Pub. Date: May 17, 2007

(54) Image recognition system and use thereof

(76) Inventors: Jacques Duparre, Jena (DE); Peter Dannberg, Jena (DE); Peter Schreiber, Jena (DE); Reinhard Volkel, Neuchatel (CH); Andreas Brauer, Schloben (DE)

Correspondence Address: KAPLAN GILMAN GIBSON & DERNIER L.L.P., 900 ROUTE 9 NORTH, WOODBRIDGE, NJ, 07095, US

(21) Appl. No.: 10/581,943

(22) PCT Filed: Jan. 19, 2005
(86) PCT No.: PCT/EP05/00495

§ 371 Date: Aug. 25, 2006

(30) Foreign Application Priority Data
Jan. 20, 2004 (DE) 102004003013.8

(51) Int. Cl. G02B 13/16

(52) U.S. Cl. 348/335

(57) ABSTRACT

The present invention relates to a digital image recognition system having a minimum constructional length of less than one millimetre. The image recognition system hereby comprises a microlens array, a detector array and optionally a pinhole array. The mode of operation of this image recognition system is based on a separate imaging of different solid angle segments of the object space by means of a multiplicity of parallel optical channels. The optical axes of the individual optical channels thereby have different inclinations so that they represent a function of the distance of the optical channel from the centre of the side of the image recognition system orientated towards the image, as a result of which the ratio of the size of the field of view to the image field size can be determined specifically. Detectors are thereby used with such high sensitivity that the detectors have a large pitch with a small active surface area.

### BACKGROUND

The invention relates to a digital image recognition system with a minimum constructional length of less than 1 mm. The image recognition system hereby comprises a microlens array, a detector array and optionally a pinhole array. The mode of operation of this image recognition system is based on a separate imaging of different solid angle segments of the object space by means of a multiplicity of parallel optical channels.

In the case of classic imaging optical systems, an individual optical channel (objective) images all the information from the object space into the image plane. The objective images the entire detectable angle range of the object space.

In S. Ogata, J. Ishida and T. Sasano, “Optical Sensor Array in an artificial compound eye”, Opt. Eng. 33, pp. 3649-3655, November 1994, an optical sensor array is presented. The optical correlations for such a general system are represented in detail. Association of the microoptics with photoelectrical image conversion is effected. Because of using gradient index lenses which are combined into an array, the number of optical channels is restricted to 16×16, the constructional length at 2.9 mm is far above that sought here. On the basis of the constructional technology which is used, it cannot be termed a monolithic system, system-integrated structure. The shown system does not seem to be scaleable with respect to length and number of channels. The field of view of the arrangement is limited by the maximum possible pitch difference between lens array and pinhole array. An arrangement of a plurality of mentioned modules on a curved base for scaling the field of view and the number of channels is proposed. However, this is entirely inconsistent with the system integration which is sought.

The publication K. Hamanaka and H. Koshi, “An artificial compound eye using a microlens array and its application to scale-invariant processing”, Optical Review 3 (4), pp. 264-268, 1996, considers the arrangement of a Selfoc lens plate in front of a pinhole array of the same pitch. Possibilities for image processing and the relatively high object distance invariance of the arrangement are demonstrated. The rear side of the pinhole array is imaged onto a CCD by means of a relay optic. There is therefore no direct connection of the imaging optic to the image-converting electronics as in [1]. The constructional length is greater than 16 mm, 50×50 channels were realized. Because of the same pitch of lens array and pinhole array, a resolution of the object is no longer possible for fairly large object distances with this arrangement. A divergent lens fitted in addition in front of the lens array produces enlargement of the angular field of view, which implies a diminishing imaging and hence enables enlargement of the object distance with constant function of the system. However this is inconsistent with the aim of integration. The pinhole diameters which are used are 140 μm which does not permit good resolution of the system.

In J. Tanida, T. Kumagai, K. Yamada and S. Miyatake, “Thin observation module by bound optics (tombo) concept and experimental verification”, Appl. Opt. 40, pp. 1806-1813, April 2001, the microimage produced behind each microlens is contained in a cell by an arrangement of a sub-group of pixels. From the different distances of the various channels from the optical axis of the array, a slight offset of the various microimages within one cell results. By means of a complicated computing formalism, these images are converted into a higher resolution total image. A Selfoc lens array of 650 μm thickness with lens diameters of 250 μm serves as imaging microlens array. The image recognition is effected centrally behind the microlenses. Separating walls made of metal and intersecting polarisation filters are used for optical isolation in order to minimise interference. Hence, individually produced components here are also adjusted relative to each other in a complex manner, which leads to the production of additional sources of error and costs. For possible extension of the limited field of view (introduction of a (negative) enlargement factor) of the system, e.g. for large object distances, a prism array is proposed with variable angles of deflection, a divergent lens or the integration of a beam deflection in diffractive lenses. As a result, the system complexity would not be increased. A concrete resolution of the system was not indicated.

Publication S. Wallstab and R. Völkel, “Flachbauendes Bilderfassungssystem”, unexamined German application DE 199 17 890 A1, November 2000, describes various arrangements for flatly-constructed image recognition systems. However, no meaningful possibility for image recognition for large object distances is indicated (widening of field of view or diminishing imaging) for the embodiment variant which is closest to the present invention. In particular a pitch difference between microlens array and pinhole array or specially formed microlenses is not mentioned.

In N. Meyers, “Compact digital camera with segmented fields of view”, U.S. Pat. No. 6,137,535, Oct. 24, 2000, a flat imaging optic with a segmented field of view is presented. A microlens array with decentralised microlenses is used here, the decentralisation depending upon the radial coordinate of the considered microlens. The axis beams of each lens point in this way into a different segment of the entire field of view, each microlens forms a different part of the field of view in its image plane. A photodetector array with respectively one sub-group of pixels behind each microlens picks up the image behind each microlens. The images corresponding to the individual field of view segments are reflected electronically and placed one beside the other. A detailed description of the necessary electronics is indicated. Baffle structures before and behind the lenses prevent interference between adjacent channels or restrict the field of view of the individual channels and hence the image size. The production of decentralised lenses or the moulds thereof is not indicated. The different components must be produced separately from each other here in addition and not for example on wafer scale possibly directly in conjunction with production of the electronics as a monolithic structure. Hence, an air gap for example is indicated between the microlens array and the detector array. Extreme adjustment complexity leads therefore to high costs in production. A significant reduction in constructional length cannot be attributed to this invention since evaluation of the individual images of the field of view segments requires a certain enlargement in the microlenses and hence a certain focal distance or section width of the lenses and consequently length of the system. The use of decentralised microlenses should hence be seen as a replacement for a large imaging lens but without effect on the constructional length of the optic as long as a significant reduction in the individual images and hence loss of effective enlargement or resolution loss is not accepted. A possible pitch difference between microlens array and detector sub-groups for producing an effective enlargement is not indicated. The effective (negative) enlargement of the entire system is consequently not increased by the cited invention. Possible system lengths which are indicated are therefore always substantially greater than 1 mm. No reference is made to the possibility of assigning respectively only one detector pixel to one microlens. Because of the free adjustability of the decentralisation independently of the enlargement of the microlens, this would lead in total to a significant increase in the (negative) enlargement of the total system or shortening with constant enlargement and also to a significant increase in the degrees of freedom for image processing.

The publication P. -F. Rüedi, P. Heim, F. Kaess, E. Grenet, F. Heitger, P. -Y. Burgi, S. Gyger and P. Nussbaum, “A 128×128 pixel 120 dB dynamic range vision sensor chip for image contrast and orientation extraction”, in IEEE International Solid-State Circuits Conference, Digest of Technical Papers, p. Paper 12.8, IEEE, February 2003, describes an electronic sensor for determining contrast. This is regarded as a very elegant way to obtain image information. Not only resolution power but also illumination strength independency and obtaining additional information relating to brightness of object sources are seen here as a possibility for taking pictures with high information content. Because of their architecture, such sensors are however provided with a low filling factor. Space filling arrays (or “focal plane arrays”) are used in order to increase the filling factor. Classic objectives are used to image the object, which increases the system length substantially and limits use of these promising sensors on an everyday basis (e.g. in the automotive field). Linking of the present invention to the mentioned sensors in exchange for the focal plane array and the macroscopic imaging optic implied extreme multiple production on the basis of significant system shortening and integration.

An optical system with a multiplicity of optical channels with respective microlens and also a detector disposed in the focal plane thereof is represented in JP 2001-210812 A. This optical system is disposed behind a conventional optic which produces the actual imaging. At the same time, the detector pixels are approx. the same size as the microlenses, as a result of which a very large angle range of the object can be imaged on a single pixel. The result of this is an imaging system with only low resolution.

A fundamental problem in production of the imaging systems known from the state of the art is the planarity of the possible technical arrangements. Off-axis aberrations, which could be avoided by the arrangement on curved surfaces limit the image quality, by production in planar technology, i.e. lithography, or restrict the field of view. These restrictions are intended to be eliminated by parts of the present invention.

### SUMMARY OF THE INVENTION

Starting from these disadvantages of the state of the art, it is the object of the present invention to provide an image recognition system which has improved properties with respect to mechanical and optical parameters, such as system length, field of view, resolution power, image size and light strength.

This object is achieved by the image recognition system having the features of claim 1. The further dependent claims reveal advantageous developments. Uses of image recognition systems of this type are described in claims 33 to 39.

According to the invention, an image recognition system is provided comprising regularly disposed optical channels having a microlens and at least one detector which is situated in the focal line thereof and extracts at least one image spot from the microimage behind the microlens. The optical axes of the individual optical channels hereby have different inclinations so that they represent a function of the distance of the optical channel from the centre of the side of the image recognition system orientated towards the image and hence the ratio of the size of the field of view of the optic to the image field size can be determined specifically. Detectors are thereby used with such high sensitivity that these have a large pitch with a small active surface area.

The described flat camera comprises a microlens array and a detector array situated in the focal plane thereof or an optional pinhole array which covers a detector array of larger active surface areas than those of the pixels. There should be understood by pixel within the scope of this application a region with the desired spectral sensitivity. In the image plane of each microlens, a microimage of the object is produced which is statically scanned by the detector or pinhole array. One or a few photosensitive pixels, e.g. with different functions such as e.g. spectral sensitivities, is/are assigned to each microlens. As a result of the offset of the photosensitive pixel which is produced in different ways within the microimage from cell to cell, the complete image is scanned and photographed over the entire array. The inclination of the optical axis of an optical channel comprising a microlens and a detector which extracts: an image spot from the microimage behind this lens or a pinhole covering the latter is a function of its radial coordinate in the array.

The imaging principle according to the invention can be used independently of the spectral range and is therefore generally usable from UV via VIS as far as deep IR, with corresponding adaptation of the materials to be used for optic and receiver to the spectral range. Use for IR sensors also seems particularly attractive since here the microlens arrays can be produced for example in silicon or germanium (or in a limited fashion also corresponding polymers), which has the advantage that no large and hence extremely expensive germanium or silicon lenses are required but only very thin microlens arrays, which leads to a significant saving in material and mass and hence a saving in costs. IR sensors often have a large pitch with a small active pixel surface area and consequently require filling factor-increasing lens arrays. The combination of conventional imaging optic with filling factor-increasing lens array can be replaced by the invention with only one imaging lens array. Thus bolometer arrays determining for example also temperature fields can be provided with ultra-flat imaging systems.

Preferably, the adjacent cells are optically isolated (cf. FIG. 2). This prevents interference which leads to a reduced signal-to-noise ratio of the imaging system. As a result of the inclined optical axes to be ensured in various ways, they observe the object space separately from or only with a minimum angular overlap to the adjacent imaging units. Each optical channel therefore provides at least one image pixel (possibly in different colours) which corresponds to a solid angle range in the object space within the field of view of the entire optic. Bringing together all the signals provided by the individual optical channels enables reconstruction of the object distribution. The mentioned arrangement can be combined advantageously in particular with photoelectronic sensors which have great sensitivity or contrast sensitivity but have a relatively large pitch in the case of small pixels (small filling factor). The described arrangement is produced with modern microoptic technologies on a system and wafer scale. Complex assembly and adjustment steps of individually produced components are consequently dispensed with. The result is the greatest possible system integration, precision and price attractiveness. The number of optical channels can be adapted corresponding to the application and can vary within the range of sensibly 10×10 to 1000×1000 channels (for high resolution images).

According to the size of the microlenses and image width (thickness of the camera), the lateral extension of the camera chip can be below 1×1 mm² but also more than 10×10 mm². Non-square arrangements are also conceivable in order to adapt to the detector geometry or to the shape of the field of view. Non-round lenses (anamorphic) for correcting off-axis aberrations are conceivable.

A combination of photographing channels with light sources (e.g. OLEDs) which are situated therebetween or thereupon is very advantageous for a further reduction in constructional length or in the necessary volume of an imaging arrangement, unlike otherwise, illumination has to be supplied from the side or in incident or transmitted light in a complex manner. Hence also the smallest and narrowest workspaces, e.g. in microsystem technology or in medical endoscopy, become accessible.

A variant according to the invention provides that correction of off-axis image errors by using different anamorphic lenses, in particular elliptical melt lenses, is made possible for each individual channel. Correction of the astigmatism and the field of view curvature makes it possible for the image to remain equally sharp over the entire field of view or image field since the shape of the lens of each channel is adapted individually to the angle of incidence to be transmitted. The lens has two different main curvature radii. The orientation of the ellipses is constantly such that the axis of a main curvature radius lies in the direction of the increasing angle of incidence and that of the other main curvature radius perpendicular thereto. Both main curvature radii increase with an increasing angle of incidence according to analytically derivable natural laws, the radii increasing with different degrees of strength. Adjustment of the main curvature radii ratio of the lens of an individual channel can be effected by adjusting the axis ratio of the ellipse base. Adjustment of the change of curvature radius from channel to channel is effected by adjustment of the size of the axes.

Furthermore, correction of the distortion, i.e. the main beam error angle, can be achieved by an adapted position of the pinhole or detector in the image of a microlens, in a variant according to the invention. Correction of the distortion is possible in a simple manner by a non-constant pitch difference between lens array and pinhole or detector array. By adaptation of the position of the pinhole or detector in the image of a microlens according to the position thereof within the entire camera and consequently of the viewing direction to be processed, the resulting total image can be produced completely without distortion. In order to be applied to a sensor array with a constant pitch, the position of the respective microlens must consequently be offset relative to the detector not only by a multiple of the pitch difference but must also be adapted to the real main beam angle to be processed.

With respect to the number of pixels per channel, the possibility exists according to the invention both that a pixel is assigned to each channel or that a plurality of pixels is assigned to each channel. A simple arrangement, as illustrated in FIG. 8, thereby requires only one single electronic pixel per channel for image production. In order to adapt to the imaging concept based on artificial compound eyes, a pixel size of the optoelectronic should be chosen corresponding to the refraction-limited spot size of approximately 2 to 3 μm, the pixel pitch requiring to be situated in the order of magnitude of 50-100 μm. Use of the free space on the sensor can take place by implementation of intelligent pixel-approximate signal pre-processing. Many image processing tasks can be dealt with already analogously in the image sensor, e.g. by operation between pixels of adjacent or only slightly distant channels. There are included in this respect for example:
Contrast, contrast direction (edge orientation)
Movement detection
Resolution increase for spot sources (for spot sources, resolution of the position in the field of view can be achieved much more precisely than the refraction limit of the optic in that the differences of the signals of adjacent chanels are evaluated for the same object spot).

Determination of the centre of gravity and the average extent of an intensity distribution.

By using a plurality of pixels with different properties or pixel groups with pixels of the same properties in the individual channels, a multiplicity of additional image information can be provided. There are involved in this respect a number of characteristics discussed below.

A resolution increase can be achieved beyond the refraction limit, so-called sub-PSF resolution (PSF=point spread function). For this purpose, groups of tightly packed similar pixels, i.e. 4 to 25 items with a size of ≦1 μm for the individual pixels must be produced for each channel. The centre of the pixel group is situated at the same point as the individual pixels according to the variant according to the invention in which only one pixel per channel is used. The centre of the pixel group is dependent upon the radial coordinate of the channel to be considered in the array.

The possibility exists furthermore of producing an electronic zoom, an electronic viewing direction change or an electronic light strength adjustment. The use of a conventional tightly packed image sensor with small pixels, e.g. a megapixel image sensor, can be used to take all the pictures produced behind all the microlenses of the array. By selecting only specific pixels from the individual channels in order to produce the desired image, the enlargement or field of view can be adjusted since the pixel position in the channel is the function of the radial coordinate of the considered channel in the array. Likewise, the viewing direction can be adjusted by simple translation of all selected pixels. Furthermore, the light strength can be adjusted by superpositions of the signals of adjacent pixels, the effective pixel size increasing, which leads to a loss of resolution.

By taking into account all the microimages, an increase in resolution can be achieved. For this purpose, a conventional tightly packed image sensor (megapixel image sensor) is used to take all the images produced behind all the microlenses of the array. The individual microimages have a minimum lateral offset relative to each other due to the different position of the individual channels relative to the centre of the array. Taking account of this minimal shift of the microimages to form a total image results in a significantly higher resolution image than when taking only one image pixel per channel. This makes sense admittedly only for small object distances which are comparable with the lateral camera extent.

Likewise, colour pictures are made possible by arrangement of colour filters in front of a plurality of otherwise similar pixels per channel. The centre of the pixel group is thereby situated at the same point as a single pixel in the case of the simple variant with only one pixel per channel, the centre of the pixel group being dependent upon the radial coordinate of the considered channel in the array. An electronic angle correction can be necessary. In order to avoid this, a combination with colour picture sensors is also possible, three colour-sensitive detector planes thereof being disposed one above the other and not next to each other.

Furthermore, an increase in light strength can be achieved without loss of resolution in that a plurality of similar pixels is disposed at a greater distance in one channel. A plurality of channels consequently looks from different positions of the camera in the same direction. Subsequent superposition of mutually associated signals increases the light strength without simultaneously reducing the angle resolution. The position of the pixel group relative to the microlens thereby varies minimally from channel to channel so that scanning of the field of view takes place analogously to the variant with only one pixel per channel. The advantage of this variant is that as a result of the fact that a plurality of channels produces the same image spot at the same time, noise accumulates only statically, i.e. it correlates with the root of the photon number but the signal accumulates linearly. The result is hence an improvement in the signal-to-noise ratio.

A further variant according to the invention provides that an arrangement is chosen in which the optical axes of at least two channels intersect in one object spot as a result of the arrangement of a plurality of pixels per channel. For this purpose, the object width must not furthermore be too great relative to the lateral camera extent, i.e. the greatest possible base length of the triangulation is crucial for good depth resolution during the distance measurement. Channels which look from different directions on to the same object spot should therefore have as great a spacing as possible. It is thereby sensible for this purpose in fact to use a plurality of pixels per channel but this is not absolutely necessary. Alternatively, also channels with respectively only one pixel can be disposed directly next to each other, said channels however looking in greatly different directions so that they enable intersection of the optical axes with pairs of channels on the opposite side of the camera. As a result of this arrangement, a stereoscopic 3D image or distance measurement, i.e. triangulation, is made possible since, for this purpose, viewing of the same object spot must occur from different angles.

By using a plurality of detector pixels per channel, the necessary number of channels can be reduced. By using a plurality of detector pixels which are decentralised differently relative to the microlens, one channel can cover different viewing directions at the same time. Having fewer necessary channels hence means that the total surface area of the camera becomes smaller. Anamorphic or elliptical lenses can nevertheless be used for correcting off-axis image errors if the detector pixels are disposed mirror-symmetrically with respect to the centre of the microlens since they respectively correct the angle of incidence.

A further variant provides the possibility of colour photos due to diffractive structures on or in front of the microlenses, these gratings being able optionally to be constant over the array but also being able to have parameters, such as orientation, blaze or period (structured gratings) which are variable from channel to channel. A plurality of similar pixels of a suitable spacing in one channel adopts the spectrum which is separated spatially by the grating. In general, the grating can also be replaced by other dispersive elements which enable deflection of different wavelengths to separate pixels. The simplest conceivable case for this would be use of the chromatic transverse aberrations for colour division, additional elements being able to be dispensed with entirely.

Another variant relates to the polarisation sensitivity of the camera. In order to influence it, differently orientated metal gratings or structured polarisation filters can be disposed in each channel in front of otherwise similar electronic pixels. The centre of the pixel group is located at the same position as the individual pixels in the case of the system which has one pixel per channel and is dependent upon the radial coordinate of the considered channel in the array. Alternatively the polarisation filters can also be integrated in the plane of the microlenses, e.g. applied for example on the latter, one channel then being able to detect only one specific polarisation direction. Adjacent channels are then equipped with differently orientated polarisation filters.

A further variant provides an imaging colour sensor, adaptation here to the colour spectrum to be processed being effected, alternatively to the normally implemented RGB colour coding, by corresponding choice of structured filters.

The pixel geometry can be adapted arbitrarily to the symmetry of the imaging task, e.g. a radial-symmetrical (FIG. 11b), a hexagonal (FIG. 11c), or an arrangement of the facets adapted in a different manner in its geometry can be chosen as an alternative to the Cartesian arrangement according to FIG. 11a.

According to a further embodiment, a combination with liquid crystal elements (LCD) can also be effected. The polarisation effects can be used in order to dispose for example electrically switchable or displaceable or polarisable pinhole diaphragms above otherwise fixed, tightly packed detector arrays. As a result, a high number of degrees of freedom of the imaging is achieved.

The functions described here can also be achieved by integration of the structures/elements differentiating the pixels of the individual channel into the plane of the microlenses. Then only one electronic pixel per channel is hereby necessary again and the channels differ in their optical functions and not only in their viewing directions. A coarser and simpler structuring of the electronics is the positive consequence. The disadvantage is the possibly necessary greater number of channels and the greater lateral space requirement associated therewith for equal quality resolution. Also a combination of a plurality of different pixels per channel with different optical properties of different channels can be sensible. Since the described system can be produced on wafer scale, it is possible, by isolating entire groups (arrays of cameras) rather than individual cameras, to increase the light strength of the photo in that a plurality of cameras simply takes the same picture (angle correction can be necessary) and these images are then superimposed electronically.

Advantages of the image recognition system according to the invention can be achieved by the following arrangements which increase the field of view or reduce the imaging scale and are adapted individually to the angle of incidence:
1. Individually generated off-axis (or decentralised) lenses, refractive (cf. FIG. 5), diffractive and hybrid, the decentralisation is a function of the radial coordinate of the considered cell in the array.
2. Microlens arrays on curved surfaces (cf. FIG. 6), the base can also have a concave configuration.
3. Integration of microprisms in lens arrays.
4. Combination of diffractive linearly deflecting structures with microlens arrays.
5. Microlens arrays comprising Fresnel or diffractive lenses with respective adaptation to the angle of incidence.

All these points can be combined as microlens arrays with parameters which are not constant over the array.

Below are some notes relating to the individual methods of various embodiments of the invention.

(See FIG. 5) Off-axis lenses with individual parameters of the individual lenses, such as decentralisation and focal distance and also conical or aspherical parameters, can for example be generated with the help of a laser writer with possible subsequent shaping. These individual lenses allow adaptation of the lens parameters for correct adjustment of the deflection direction and also correction of the off-axis aberrations for the central main beam. The lenses are decentralised over the centre of the cells in order to effect a deflection. This function can also be interpreted as prism effect. In this embodiment, the pinholes can remain centred in the individual cells but also can be offset from the centre of the cell as a function of the radial coordinate of the considered cell in the array. In addition to decentralisation of the lens, this causes a further enlargement of the field of view.

(See FIG. 6) Microlens arrays on curved surfaces can likewise be generated with the help of a laser writer and shaping or by shaping of conventionally produced microlens arrays with deformable embossing stamps. According to the application, all the microlenses can have the same parameters or the lens parameters must be varied, that each microlens always focuses on the corresponding receptor in fact (cf. FIG. 6). Separating walls for avoiding interference are also advantageous here. As a result of the arrangement of the microlens arrays on a curved surface, the optical axes of the arrangement are automatically inclined. Off-axis aberrations are avoided since the central main beams always extend perpendicularly through the lenses.

Refractive deflecting structure analogous to 1, possibly on separate substrates.

The function of an off-axis lens can be achieved also by combination of a melt lens array of identical lenses with diffractive, linearly deflecting structures which are adapted individually to the cell as a function of the radial coordinate of the cell in the array→hybrid structures.

The structure heights which can be produced with the help of e.g. a laser writer are limited. Microlens arrays with lenses of a high apex height and/or high decentralisation can rapidly exceed these maximum values if smooth, uninterrupted structures are demanded for the individual lenses. The sub-division of the smooth lens structure into individual segments and respective reduction to the lowest possible height level (large integer multiple of 2π) results in a Fresnel lens structure of a low apex height with respective adaptation to the angle of incidence which transcends in the extreme case of very small periods into diffractive lenses.

Furthermore, a useful adaptation of the sampling angle to the acceptance angle can be achieved by widening the field of view whilst keeping the overall image field size and size of the acceptance angle of the individual optical channels the same.

A significant improvement in the properties of the described invention can be achieved by an additional arrangement of detectors on a curved base as illustrated in FIG. 7. The curvature radius of the spherical shell, on which the detectors are located, should be chosen to be precisely that much smaller than that of the spherical shell on which the microlenses are located that microlenses of the same focal distance on the first spherical shell focus exactly on the receptors on the second spherical shell. The two spherical shells are concentric. As a result of choice of this arrangement, imaging of a large field of view results without off-axis aberrations since an optical channel for one object spot to be imaged precisely by the latter is always axis-symmetrical. Identical microlenses can be used.

Imaging systems occurring in nature, i.e. eyes, have, as far as we know, without exception curved retinas (natural receptor arrays). This applies both to single chamber eyes and to compound eyes. Due to the curvature of the retina, a significant reduction in field-dependent aberrations (image field curvature, astigmatism) and hence a more homogeneous resolution power and a more uniform illumination over the field of view is achieved. In the case of compound eyes, a very large field of view is consequently made possible and as a result of the simultaneous arrangement of the microlenses on curved bases. Even with simple lens systems, high resolution images of the environment can thus be produced.

The substantial advantages of a curved relative to a planar arrangement include: (i) Large field of view results automatically; and (ii) each channel operates “on axis” for the viewing direction to be processed and is hence free of field-dependent aberrations and from a drop in the relative illumination strength over the field of view (“cos ˆ4 Law”).

Semiconductor technology which has been established in the last decades and microoptic technology which has emerged therefrom are planar technologies. For this reason only flat optoelectronic image sensors for example have been available to date and there are only planar microlens arrays. Complex optic design and voluminous, multi-element optics are the consequence of necessary correction for a flat image plane in order to produce qualitatively high quality imaging. The development of curved optoelectronic image sensors and hence borrowing of a concept which has been used for millions of years in nature as an optimum design promises a significant simplification in the necessary optics with an influence on price, volume and field of use of future products. In addition to the inherent aberration correction, completely new applications, such as e.g. all round view, could be made possible.

Artificial equivalents to this natural approach can be achieved on the basis of the following novel microoptic technologies: (i) Generation of microlens arrays on a base which has a convex or concave, cylindrical or spherical configuration (use of laser writer NT) or shaping of microlens arrays produced with a planar configuration by means of a flexible silicon tool on a curved base; and (ii) Walls for optical isolation of the channels are likewise disposed on a curved base, i.e. they do not surround laterally cuboid transparent volumes between lens and image plane thereof, but instead truncated cone or truncated pyramid volumes.

For receiver arrays on curved bases, the following three production technologies, inter alia, are conceivable:

Conventionally produced image sensors are greatly thinned to a few μm or 10 μm and applied on curved bases and possibly illuminated through the rear side. Because of mechanical tensions occurring during the curvature, a cylindrical curve appears promisingly for a short while as a spherical curve which admittedly is not precluded. By means of a cylindrical curve (curvature radius up to 2-3 cm), numerous applications which require a large field of view only in one direction can already be used.

Structuring of the optoelectronics directly on curved bases by means of adapted lithographic methods (e.g. laser writer NT). Production of spherical curves should not be regarded here as substantially more critical/complex than those of cylindrical ones. Admittedly this is a completely novel technology for production of optoelectronics.

Polymer receiver arrays are applied on curved carriers in the form of a film.

A flexible version of the entire flat camera is likewise conceivable since the flat objective can be replicated potentially in a deformable film and, using polymer receiver arrays, the electronics might cope also with corresponding curves. Hence a camera might be made possible with which a significantly extended object field can be observed at only a few millimetres remove. The field of view would then also be adjustable by the choice of the curvature radius of the base on which the camera is placed.

For industrial manufacture of the ultra-flat objective, simultaneous front and rear hot-embossing/UV casting into a thin plate or film which can be simply placed on the sensor array and glued thereto seems particularly advantageous. The lens arrays are hereby embossed on the front side and, on the rear side, the intersecting troughs which, by subsequent filling with black or absorbing cast material, are the optically isolating walls of the channels. The shaping tools of the lens arrays for hot-embossing can be produced for example by galvanic shaping of the original shapes, whilst transparent tools are necessary for the UV casting. Moulds/tools of optical structures can, independently of whether the same lenses or lenses of varying parameters are used (“chirped lens arrays”), are produced, e.g. by the reflow process, grey clay lithography, laser writing, ultra-precision machining, laser ablation and combinations of these technologies, and can also comprise lenses with integrated prisms or gratings or lens segments which are offset relative to the centre of the channel. The moulds/tools for the intersecting walls can be produced for example by lithography in a photosensitive resist (SU8) which can be structured with a very high aspect ratio or by ultra-precision machining, such as form boring of round or milling of square or rectangular trough structures, the Bosch silicon process (deep dry etching with a very high aspect ratio), wet etching of silicon in KOH (anisotropically), the LIGA process or by laser ablation. Production of these walls by a planar illumination of a substrate which is unstructured on the rear with a high performance laser, so-called Excimer laser, through a lithographic mask with intersecting webs and resulting blackening of the illuminated regions is likewise conceivable, the black walls being produced by bombardment. The same effect can be achieved by machining of the material with a focused laser bundle of high power, the intersecting walls then being produced as lines of a scanning deflection of the laser focus. The black walls are inscribed here into the material.

During production of moulds/tools by ultra-precision machining machines, great surface roughness possibly results. This can be compensated for or minimised e.g. by spray coating (“spray painting”) with a thin polymer film of a suitable refractive index (prisms, aspherical lens segments, (blazed) gratings, intersecting 1D array structures).

Planar glueing of the ultra-flat optic to the sensor leads to a significant reduction in Fresnel reflection losses since two boundary faces to air are eliminated.

The shape of the black walls need not necessarily be such that the transparent volumes of the channels are cubes but can also result in transparent conical or pyramid-like spacing structures between lens array and the image plane.

Replication of the described structures from the film roll allows economical continuous manufacture. Production of thin boards is likewise conceivable. Many thin objectives are produced simultaneously.

There can be used as replication technologies moulding in UV curable polymer (UV reaction moulding), embossing or pressing on plastic material film (double sided), configuration as plastic material compression moulding or injection moulding part, hot-embossing of thin plastic material plates and UV reaction moulding, directly on optoelectronic wafers.

There are conceivable as possible applications for the mentioned invention, use as integral component in flatly-constructed small appliances, such as for example, clocks, notebooks, PDAs or organisers, mobile telephones, spectacles, clothing items, for monitoring and safety technology, and also for checking and implementing access or use authorisation. A further highly attractive application is use as a camera in a credit card or in general a chip card. A camera as a stick-on item and as an ultra-flat image recognition system for machine vision also in the automotive field and also in medical technology is made possible by the arrangement according to the invention.

The photographing pixels in the camera do not necessarily require to be packed tightly but can also alternate for example with slightly extended light sources, e.g. LEDs (also in colour). Hence photographing and picture reproducing pixels are possible distributed uniformly in large arrays for simultaneous photographing and picture reproduction.

Two such systems can be applied on the front and rear sides of an opaque object, each system respectively reproducing the image taken by the other system. If the size of the object is approximately similar to the camera extent, the inclined optical axes resulting for example from pitch difference of lenses and pinhole array can be dispensed with and the pinholes or detectors can be disposed directly on the axis of the microlenses, the result is a 1:1 image. The following areas of use are, for example, conceivable: (i) “Wearable displays” combined with corresponding photographing→camouflage (“transparent human”), camouflaging of vehicles, aeroplanes and ships by applying on the outer skin→“transparency”; and (ii) Adhesive films or wallpapers→transparent door, transparent wall, transparent . . .

The image recognition system according to the invention can be used likewise in the endoscopy field. Hence a curved image sensor can be applied for example on a cylinder sleeve. This enables an all round view in organs which are accessible for endoscopy.

A further use relates to solar altitude detection or the determination of the relative position of a punctiform or only slightly extended light source to a reference surface firmly attached to the flat camera. For this purpose, a relatively high and possibly asymmetric field of view is required, approximately 60°×30° full angles.

A further use relates to photographing and processing so-called smart labels. As a result, a reconfigurable pattern recognition can be achieved for example by using channels with a plurality of pixels according to FIGS. 9b or 9d. This means that the view direction of each channel can be electronically switched, as a result of which redistribution is produced in the assignment of image and object information. This can be used for example in order to define other object patterns from time to time without the camera requiring to be changed. The use likewise relates to recognition and identification of logos.

A further application field relates to microsystem technology e.g. as a camera for observing the workplace. Hence for example grippers on chucks or arms can have corresponding image recognition systems. Involved herein is also the application in the “machine vision” field, e.g. small-scale cameras for pick and place robots with great enlargement and simultaneously high depth sharpness but also for all round view, e.g. for inspections of borings. A flat camera has enormous advantages here since absolutely no high resolution is required but instead only high depth sharpness.

A further use relates to 3D movement tracking, e.g. of the hand of a person or the whole person for conversion into 3D virtual reality or for monitoring technology. For this purpose, economical large-area receiver arrays are required which is fulfilled by the image recognition systems according to the invention.

Further uses relate to iris recognition, fingerprint recognition, object recognition and movement detection.

Likewise sensory application fields in the automobile field are preferred. Involved herein are for example monitoring tasks in the vehicle interior or exterior, e.g. with respect to distance, risk of collision of the exterior, interior or seat arrangement.

Contemporary optical cameras have too high a spatial requirement (vehicle roof, rear mirror, windscreen, bumper etc.), cannot be integrated directly and are too expensive for universal use. As a result of the extremely flat construction, camera systems of this type are ideal for equipping and monitoring the interior (e.g. interior vehicle roof) of an automobile without thereby impinging excessively on the eye and without representing an increased risk of injury in the case of possible accidents. They can be integrated relatively easily into existing concepts. Of particular interest are image-providing systems fitted in the interior for intelligent and individual control of the airbag according to the seating position of the person. For the known problems in connection with airbag technology (out-of-position problem, unauthorised triggering), intelligent image-providing sensors could offer solutions.

Ultra-flat camera systems can be integrated without difficulty in bumpers and function thereby not only as distance sensors but serve for detecting obstacles, objects and pedestrians, for controlling traffic and for pre-crash sensor systems. In the average monitoring range of approximately 50 to 150 m, the use of image sensors, in addition to pure distance sensors (radar-lidar technology) which offer no location resolution or little location resolution, is of increasing importance. Use of flat cameras in the infrared spectral range is also conceivable. The flat and inconspicuous construction represents an unequivocal advantage of these innovative camera concepts relative to conventional camera systems.

A further future possible use in the field of automobile technology resides in using ultra-flat camera systems as image-recognition systems for physical and logical access control and for implementing authorisations for use. Ultra-flat camera systems could thereby be integrated in a key or be fitted in the interior and enable authentication of the user on the basis of biometric features (e.g. facial recognition).

Further application fields are produced as an integratable image-providing sensor in the case of innovative driver assistance systems for active security and travelling comfort:
Lane detection,
Pedestrian and obstacle monitoring
Blind spot monitoring, vehicle interior monitoring, attentiveness of the driver, comfort
Night vision camera

In the air travel industry field, such as e.g. integrated and intelligent cockpit monitoring by means of inconspicuous extremely flat camera systems.

Both CMOS and CCD sensors can be used for photoelectric image conversion. Particularly attractive here are thinned and rear-lit detectors since they are suitable in a particularly simple manner for direct connection to the optic and in addition have further advantages with respect to sensitivity.

### BRIEF DESCRIPTION OF THE DRAWINGS

With reference to the subsequent Figures, the subject according to the invention is intended to be explained in more detail without wishing to restrict the latter to particular embodiment variants.

FIG. 1 shows a side view of an embodiment variant of the ultra-flat camera system necessarily comprising a microlens array, substrate and pinhole array. Due to a somewhat smaller pitch of the pinhole array compared with the lens array, the direction of the optical axes migrates outwards if one moves towards outer channels. This arrangement can be placed directly on an electronic unit with suitable pixel pitch without a spacing.

FIG. 2 shows an embodiment variant analogous to FIG. 1 but with light-protective walls. A screening layer is located on a substrate which can also be replaced by the photosensitive electronic unit as carrier. Transparent towers form the spacer between microlenses and pinholes. The intermediate spaces between the towers are filled with non-transparent (absorbent) material in order to achieve optical insulation of the individual channels.

FIG. 3 shows a possible production process for the variant in FIG. 2. According to variant 7, substrates are coated with the pinhole array. According to variant 8, SU8 pedestals (towers) are applied, the intermediate spaces between the towers are filled with absorbent material (PSK). According to variant 9, microlens arrays are applied adjusted to the pinhole arrays.

FIG. 4 shows a representation of an embodiment variant, 300 μm thick substrate with pinhole array on the rear side and UV-shaped microlens array with a polymer thickness of 20 μm on the front side. From the pitch difference between microlens and pinhole array, the result is inclined optical axes and hence an effective reduction. This arrangement can be glued directly on an image-providing electronic unit with pitches adapted to pixels.

FIG. 5 shows an ultra-flat camera with a lens array comprising off-axis lens segments, the decentralisation is dependent upon the viewing direction of the channel or upon the radial position in the array (prism effect).

FIG. 6 shows an ultra-flat camera with lens array on a curved base, the focal distances of the lenses are channel-dependent. Despite a large field of view there are no off-axis aberrations for the central main beams since these are always perpendicular to the lens base. Likewise, a divergent lens is conceivable as base, the resulting total image is then reversed.

FIG. 7 shows an ultra-flat camera with lens array and detector array on a curved base. The focal distances of the lenses can all be the same here. Despite a large field of view there are no off-axis aberrations for the central main beams since these are always perpendicular to the lens base. A divergent lens is also conceivable as base, the resulting total image is then reversed.

FIG. 8 shows a side view of an image recognition system according to the invention with one pixel per optical channel.

FIG. 9 shows different variants for use of a plurality of pixels per optical channel.

FIG. 10 shows examples of the integration of additional optical functions in the image recognition system according to the invention.

FIG. 11 shows examples of geometric arrangements of the optical channels.

FIG. 12 shows schematically the production method of the image recognition systems according to the invention.

FIG. 13 shows different variants of the geometric configuration of the optical channels.

FIG. 14 shows the image recognition system according to the invention in combination with a liquid lens (electronic zoom).

### DETAILED DESCRIPTION OF THE EMBODIMENTS OF THE INVENTION

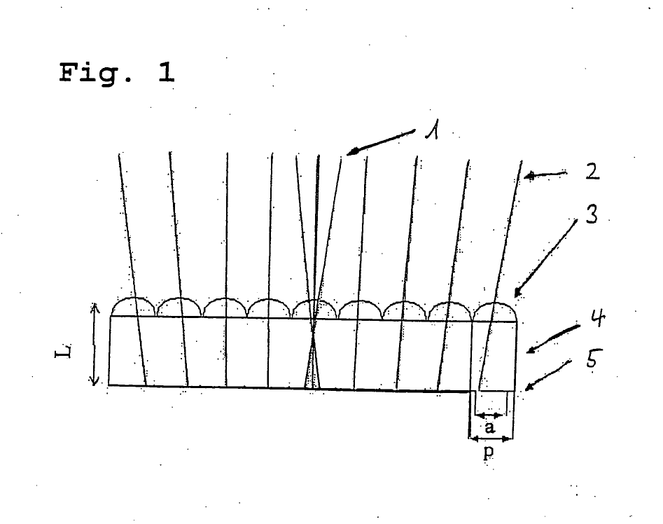

FIG. 1 shows a variant of the subject according to the invention. In FIG. 1 the following reference numerals mean: 1, Acceptance of an optical channel (Δφ); 2, Sampling of the FOV (sampling angle ΔΦ); 3, Lens array, lenses with diameter D and focal distance f are centred in cells with pitch p; 4, Substrate; and 5, Pinhole array (in metal layer), pinhole offset in cells determines viewing direction, diameter of the pinhole d determines acceptance angle Δφ

Optical axes which can be produced in different ways (hereby pitch difference of the microlens array and the pinhole array) and which increase outwards in inclination in order to achieve the (negative) enlarged imaging mean that a source in the object distribution delivers only one signal in a corresponding photosensitive pixel if it is located on or near to the optical axis of the corresponding optical channel. If the source point is moved away from the considered optical axis, then the signal of the corresponding detector drops but one associated with a different optical channel adjacent thereto, the optical axis of which the source point now approaches, possibly rises. In this way, an object distribution is represented by the signal strengths of the corresponding mentioned detector pixels.

This arrangement provides an image of the object with significantly greater enlargement than can be observed behind an individual microlens, with significantly shorter constructional length than classic objectives with comparable enlargement.

As a function of the radial coordinate of the considered cell in the array, the inclination of the optical axes can increase both outwardly (FIG. 1), i.e. away from the optical axis of the array and inwardly, i.e. towards the optical axis of the array. The result is either an upright or a reversed total image.

The resolution power of the mentioned invention is determined by the increment of the inclination of the optical axes, the sampling angle ΔΦ and by the solid angle which is reproduced by an optical channel as an image spot, the so-called acceptance angle Δφ. The acceptance angle Δφ is produced from folding of the point spread function of the microlens for the given angle of incidence with the aperture of the pinhole, or active surface of the detector pixel and the focal length of the microlens. The maximum number of resolvable pairs of lines over the field of view is now precisely half the number of the optical channels if the acceptance angles (FWHM) thereof are not greater than the sampling angle (Nyquist criterion). If the acceptance angles are however very large compared with the sampling angle, then the number of optical channels no longer plays a role, instead the period of resolvable pairs of lines is as great as the acceptance angle (FWHM). A meaningful coordination of Δφ and ΔΦ is hence essential.

According to the size of the photosensitive pixels, covering of the detector array with a pinhole array can be necessary. This increases the resolution power but reduces the sensitivity/transmission of the arrangement because of the smaller detector surface area.

Alternatively to only one active pixel per optical channel, also a plurality of pixels of different functions can be used in one optical channel. Thus for example different colour pixels (RG) can be disposed in one cell, or pixels with large spacings within one cell which produce (scan other points of the microimage in one cell) different viewing directions (inclinations of the optical axes) and, as a result of an overlap with viewing directions of other such pixels in further removed cells in order to increase the sensitivity of the total arrangement, act without loss of resolution.

Within the scope of the present invention, pinhole diameters which are deemed sensible and hence desired, are from 1 μm to 10 μm.

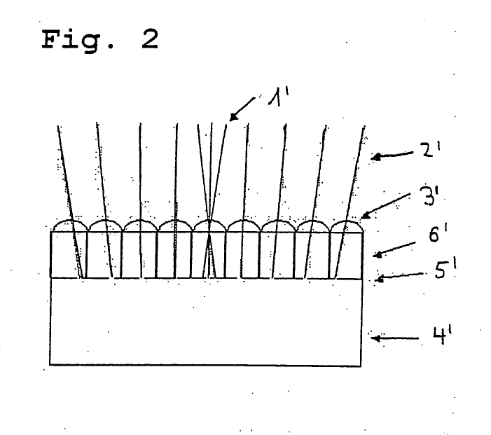

In FIG. 2 a similar arrangement to FIG. 1 is represented but with lithographically produced separating walls between the individual cells. In FIG. 2 the following reference numerals mean: 1′, Acceptance range of an opt. channel (PSF pinhole/focal distance); 2′, Sampling of the FOV (pinhole offset/focal distance); 3′, Lens array, lenses centred in cells; 4′, Substrate (only as carrier); 5′, Pinhole array (metal diaphragms), pinhole offset to produce the FOV; and 6′, Cells with light-protective walls.

These light-protective walls have the effect that source points which are located outwith the actual field of view of a channel are imaged by said channel on detectors of the adjacent channel. As a result of the strong off-axis aberrations during imaging of obliquely incident bundles, the thus transmitted image spots are however strongly defocused. A significant reduction in signal-to-noise ratio of the imaging would be the result.

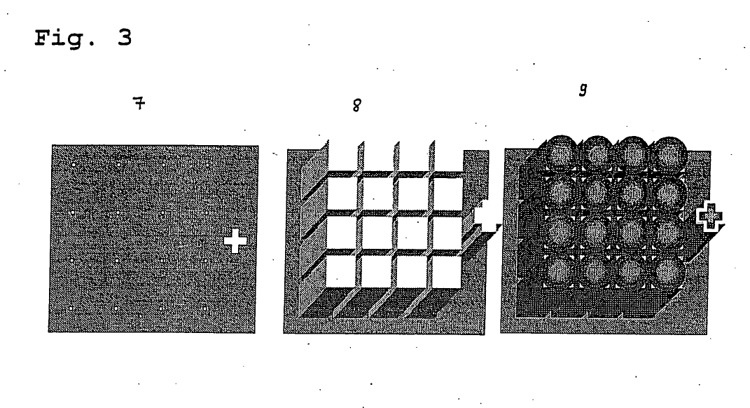

FIG. 3 shows a possible lithographic production variant of a system with light-protective walls. The flat camera can be applied to the electronic unit in the end effect as a thin polymer layer which then serves simultaneously as substrate.

For the production of lenses, the most varied of technologies are conceivable. Thus technologies established in microoptics, such as the reflow process (for round or elliptical lenses), moulding of UV curable polymer (UV reaction moulding) or etching (RIE) in glass, can be used. Spheres and aspheres are possible as lenses. Further variants of production can be embossing or printing onto a plastic material film. The configuration as a plastic material, compression moulding or injection moulding part or as hot-embossed thin plastic material plate, into which the separating walls (“baffles”) can be recessed already, is likewise conceivable. The lenses can have a refractive, diffractive or refractive-diffractive (hybrid) configuration. The system can possibly be embossed directly on the electronic unit by centrifuging a polymer or can be shaped in another manner.

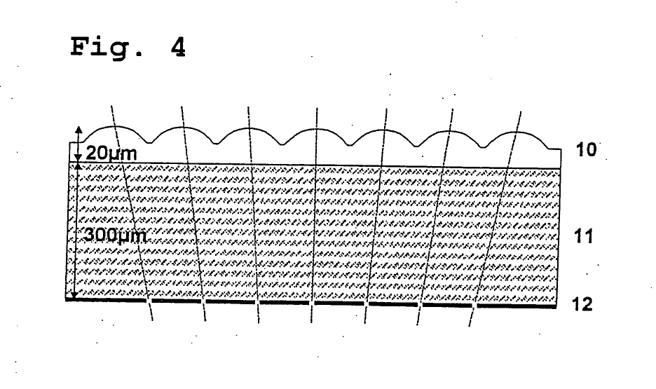

FIG. 4 shows an already produced embodiment variant. A 20 μm thick polymer layer 10 on the front side of a 300 μm thick glass substrate 11 contains the necessary microlenses. On the rear side of the substrate there is located a pinhole array 12 of a slightly smaller pitch than the microlens array in a metal layer. This arrangement produces an image of the object with significantly greater enlargement than can be observed behind an individual microlens, with a significantly shorter constructional length than classic objectives with comparable enlargement. The substrate thickness is set equal to the focal distance of the microlenses so that the pinhole array is located in the image plane of the microlens array.

The lens diameter is 85 μm, the size of the scanned image field 60 μm×60 μm, the pitch of the optical channels is 90 μm. The field of view for rotational-symmetrical lenses is restricted to 15° along the diagonal by the sensible NA of the lenses of 0.19. The number of optical channels is 101×101, to which the number of produced image spots corresponds.

The pinhole array necessary for covering the detector array comprises a material of low-minimum transmission. In particular metal coatings are suitable for this purpose. These do however have the disadvantage of high reflectivity, which leads to scattered light within the system. Replacement of the metal layer by a black polymer structured with pinholes is advantageous for reducing the scattered light. A combination of black polymer layer and metal layer allows low transmission with simultaneously low reflection.

Essential advantages of the invention represented here are the possibilities for adjusting the enlargement of the total system, i.e. the ratio of the size of the field of view of the optic to the image field size. From the production of a flat camera with a homogeneous lens array, i.e. all the lenses are equivalent, in lithographical planar technology, the result is a restriction in the field of view of the total arrangement. The complete size of the field of view is then provided by FOV=arctan (a/f), a being the size of the scannable microimage (can at most be as great as the lens pitch p) and f being the focal distance of the microlens (see FIG. 1). The microimage can only be scanned meaningfully as long as the scanning pinhole does not migrate out of the image range of the corresponding microlens. An enlargement of the image range can, when using the largest possible filling factor for the microlens array, only imply that also the lens diameter (in a square arrangement equal to lens pitch p) must be enlarged. Hence taking into account NA=p/2f, in the ideal case a=p, with NA as numerical aperture of the microlens, the above equation for calculation of the field of view can be transcribed to FOV=arctan (2NA). The size of the field of view of the described arrangement is hence determined by the size of the numerical aperture of the microlens. An arbitrary enlargement of the NA of the lenses is not possible because of the increase in size of the aberrations, even when using aspherical microlenses due to the large angle spectrum to be processed.

A sensible possibility for adjusting the pitch difference between microlens array and pinhole array is Δp=a (1−N/(N−1)) with N as the number of cells in one dimension of the flat camera.

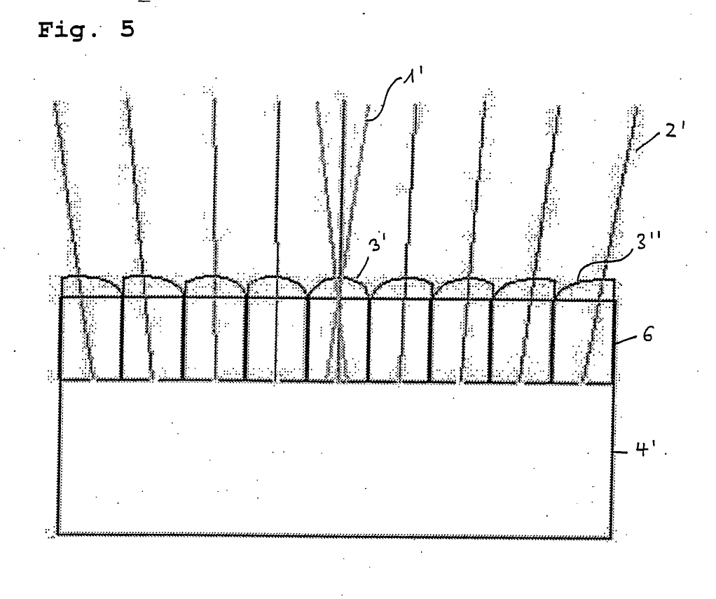

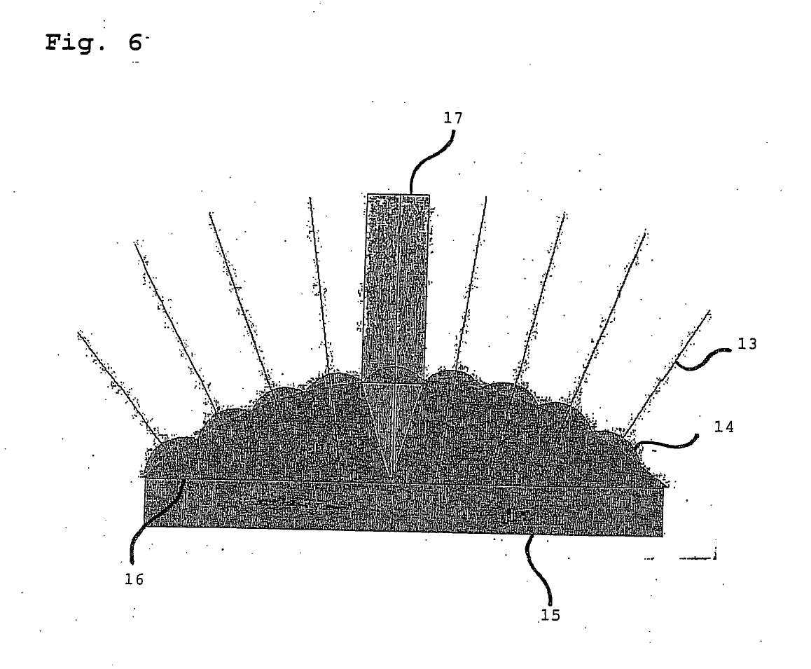

A combination of a pitch difference between microlens array and pinhole array with deflecting elements (FIG. 5) or the arrangement of lenses or of the complete optical channels, i.e. including detectors, on a curved base (FIG. 6) appears, as a possible solution, to enlarge the field of view with the same image field size and hence to reduce the enlargement of the total arrangement. The extension of the field of view or reduction in enlargement by different methods which are described here and can be combined with each other is an essential point of the present invention.

FIG. 6 shows an image recognition system according to the invention with a lens array comprising individual microlenses 14 and a detector array with individual detectors 15. The lens array is thereby disposed on a curved surface. The optical axes 13 are stratified, as a result of which an extension of the field of view is achieved.

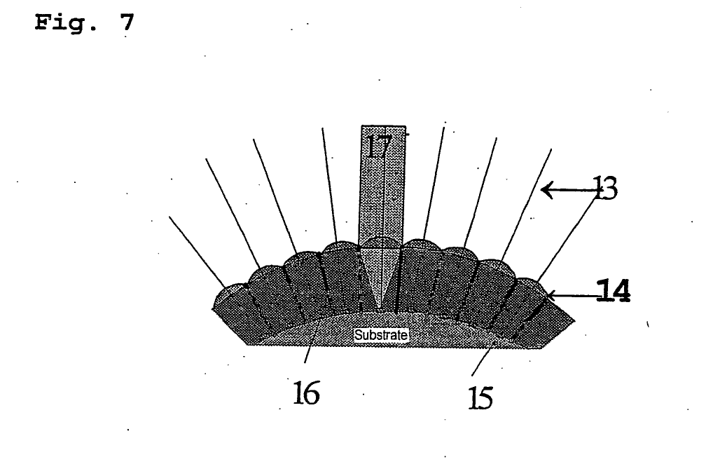

FIG. 7 shows an image recognition system according to the invention having a lens array with individual lenses 14 and a detector array with individual detectors 15 on a curved base. The focal distances of the lenses can all be the same here. Despite the large field of view there are no off-axis aberrations for the central main beams since these are always perpendicular to the lens base. Likewise a diffractive lens as base is conceivable, the resulting total image is then reversed. The optical isolation of the individual channels by suitable separating walls is also essential here in order to suppress ghost images caused by interference between adjacent channels.

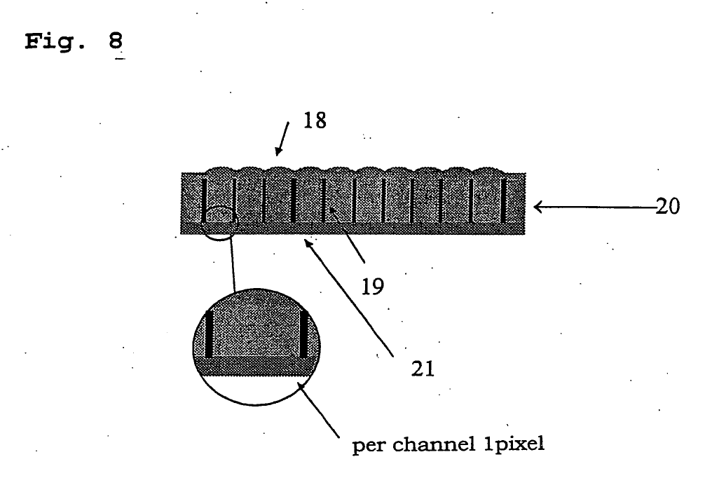

FIG. 8 shows a side view of the image recognition system according to the invention in a planar embodiment with one pixel of a suitable size per channel. It comprises microlens array 18, distance-defining structure for the image plane and optical isolation 19 of the channels in order to suppress interference in a monolithic plate 20 which is placed directly on the image sensor 21. Due to a somewhat smaller pitch of the pixels of the image sensor compared with that of the lens array, the relative position of the sensor pixel to the microlens is different in each channel, as a result of which the necessary variation in viewing direction amongst the channels is achieved. The section shows the possible pixel position within the channel for a channel at the edge of the camera.

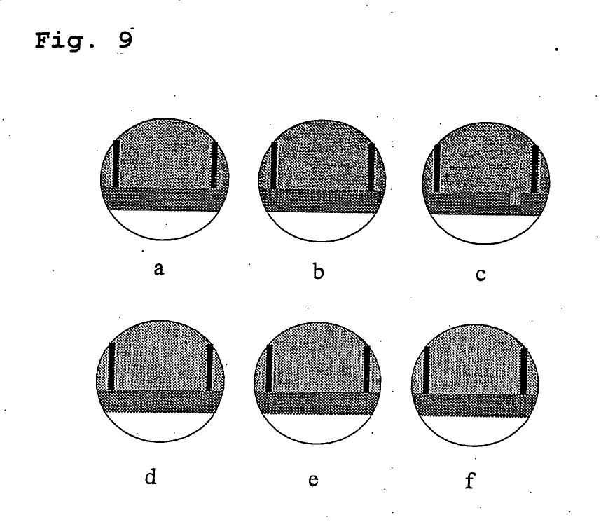

FIG. 9 shows possibilities for using a plurality of pixels per channel, the sections are illustrated respectively in the image plane of a channel corresponding to FIG. 8. FIG. 9a shows a Sub-PSF-resolution, i.e. group of very small pixels instead of the previous individual pixel. FIG. 9b shows a tightly packed sensor array in image plane of the microlenses, so-called megapixel sensor. FIG. 9c shows a colour filter in front of various pixels of a channel allow a colour photo. It should be taken into account hereby that different colours are taken with various viewing directions, i.e. there is a different offset of the colour pixels relative to the microlens. This can be made possible by a corresponding correction by switching not the colour pixels of a channel into a colour image pixel but different colour pixels of adjacent channels looking correspondingly in the same direction, e.g. red pixel of channel 1 looks in the same direction as blue pixel of channel 2. Likewise integration of the different colour filters in the plane of the microlenses is conceivable, different channels then detecting different colours, however having the same viewing direction. FIG. 9d shows an arrangement of a plurality of similar pixels at a greater spacing in one channel, i.e. a plurality of channels looks in the same direction with pixels respectively situated relatively differently in the channel. The position of the pixel group relative to the lens is easily displaced from channel to channel. FIG. 9e shows an arrangement of a plurality of similar pixels at a small spacing in one channel, e.g. in order to photograph a spectrum. FIG. 9f shows the polarisation filter is integrated directly in the optoelectronic pixels. Alternatively, also polarisation filters can be placed on or in front of the microlenses and different polarisation directions can be detected by separate channels.

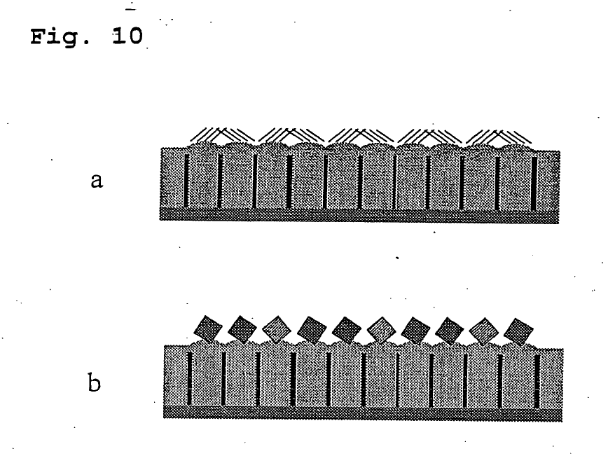

FIG. 10 shows the integration of additional optical functions which are different from channel to channel in the plane of the microlens array. Thus FIG. 10a shows an integrated polarisation filter or a grating serving the same purpose, whilst an integrated colour filter is represented in FIG. 10b.

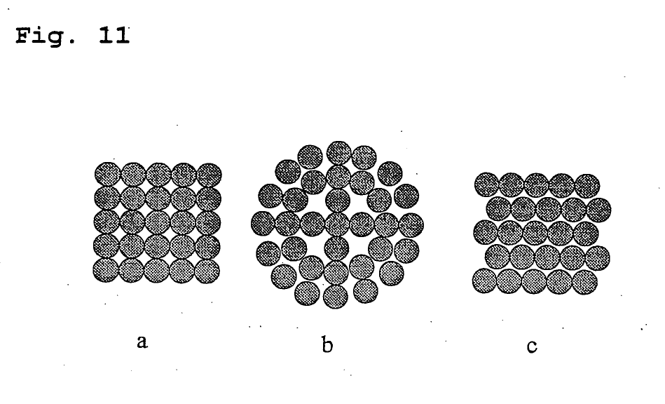

FIG. 11 shows different variants of the geometrical arrangement of the optical channels in the array. In FIG. 11a, a Cartesian arrangement of optical channels is represented, in FIG. 11b, a radial-symmetrical arrangement of the optical channels, whilst a hexagonal arrangement of the optical channels is present in FIG. 11c.

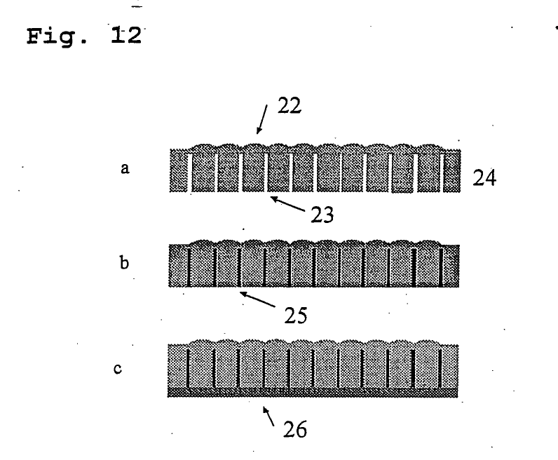

FIG. 12 shows schematically an industrially relevant production technology via if necessary simultaneous front and rear side shaping of the ultra-flat objective by e.g. hot-embossing or UV reaction moulding and subsequent casting with absorbent material. In FIG. 12a, lens arrays 22 (homogeneous variable parameters, additional integrated functions (grating)) are formed on the front side. On the rear side, trough structures 23 are embossed as deeply as possible into the plate 24 or the film. The result is transparent, weakly connected towers which serve as spacers of the microlenses located thereon up to the image plane thereof. In FIG. 12b the intermediate spaces between the towers are filled with non-transparent (absorbent) material in order to achieve optical isolation 25 of the individual channels. In FIG. 12c the resulting objective plate or the film can be placed directly on the image sensor 26 (even on wafer scale). Highly precise lateral adjustment is hereby necessary according to the sensor array which is used.

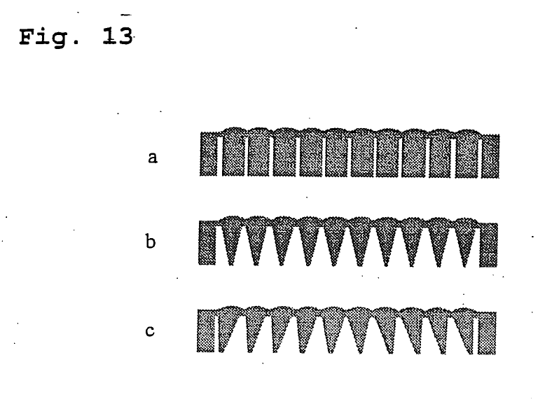

FIG. 13 shows various forms of the transparent towers resulting from embossing, so-called spacing structures. In FIG. 13a straight walls in e.g. Cartesian arrangement lead to cubes as enclosed transparent volumes of the channels. In FIG. 13b oblique, conical or pyramid-like walls lead to truncated cones or truncated pyramids as enclosed transparent volumes of the channels. This would also be well suited to shaping on curved surfaces. In FIG. 13c tilting or the shape of the transparent volumes (spacing structures) can necessarily be different from channel to channel, in order to be adapted to the inclination of the optical axis of the respective channel. Subsequently in order to form the spacing structures, casting of the rear side with absorbent material is effected here too in order to generate the optical isolation of the channels.

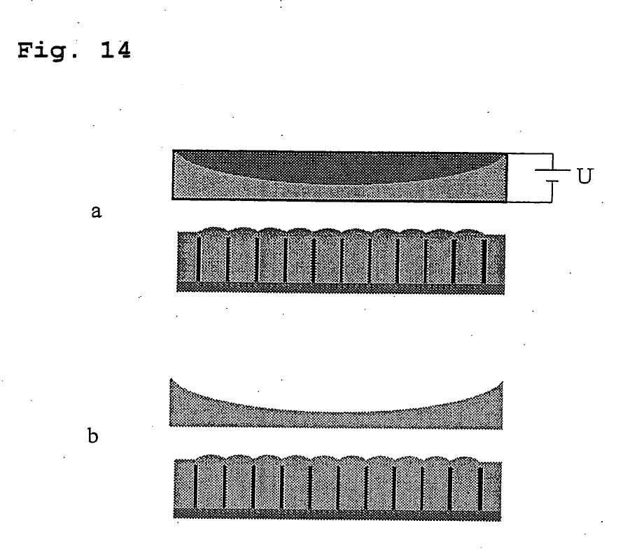

FIGS. 14a-b show a combination of the image recognition system according to the invention with pre-connected deflecting structure for changing the field of view (zoom). This can be for example a liquid lens with an electrically adjustable variable focal distance for a flexible, purely electrooptical zoom during operation of the camera.

A fixable (single) adjustment of the field of view independently of the parameters of the camera chip itself is pre-connection of a set focal distance lens with a suitable focal distance. Whether concave or convex lenses are chosen determines the orientation of the image or the sign of the image scale. The pre-connected lenses can be configured also as Fresnel lenses in order to reduce the constructional length. Pre-connection of a prism causes in addition corresponding adjustment of the viewing direction of the entire camera. The prism can also be configured as a Fresnel structure.

1. An image recognition system comprising regularly disposed optical channels having at least one microlens and at least one detector, which is situated in a focal plane thereof and extracts at least one image spot from a microimage behind the microlens, an optical axes of the individual optical channels having different inclinations in such a manner that they represent a function of a distance of the optical channel from a centre of a side of the image recognition system which is orientated towards the image, by means of which a ratio of a size of a field of view to an image field size can be determined specifically, and detectors are used with such high sensitivity that these have a large pitch with a small active surface area.

2. The image recognition system according to claim 1, wherein each optical channel detects at least one specific solid angle segment of the object space as corresponding image spot so that a totality of the transmitted image spots on the detector allows reconstruction of the object.

3. The image recognition system according to claim 1, wherein a central spacing, or pitch, of the microlenses differs slightly from a pitch of the detectors in order to ensure a different inclination of the optical axes for the individual channels.

4. The image recognition system according to claim 1, wherein the individual microlenses differ with respect to decentralization relative to the detector, a focal distance, conical and/or aspherical parameters and hence enable different inclinations of the optical axes.

5. The image recognition system according to claim 1, wherein microprisms which enable different inclinations of the optical axes are integrated in the individual microlenses.

6. The image recognition system according to claim 1, wherein the individual microlenses are disposed on a base which has a convex or concave configuration and hence enable different inclinations of the optical axes.

7. The image recognition system according to claim 1, wherein the detectors are disposed on a base which has a convex or concave configuration.

8. The image recognition system according to claim 1, wherein the optical channels are free of off-axis aberrations for different inclinations of the optical axes.

9. The image recognition system according to claim 1, wherein the individual optical channels have at least one of: (i) different pitch differences between microlens and detector; and (ii) at least one pinhole for correction of distortion.

10. The image recognition system according to claim 1, wherein the image recognition system has a constructional length of less than 1 mm.

11. The image recognition system according to claim 1, wherein a number of optical channels is in the range of about 10×10 to 1000×1000.

12. The image recognition system according to claim 1, wherein a size of the optical channels is in the range of about 10 μm×10 μm to 1 mm×1 mm.

13. The image recognition system according to claim 1, wherein the regular arrangement of the optical channels are packed tightly in at least one of: a square, (ii) a hexagon, and (iii) a rotational-symmetrical arrangement.

14. The image recognition system according to claim 1, wherein the positions of the microlenses and of the detectors are precisely defined lithographically.

15. The image recognition system according to claim 1, wherein the optical channels are optically isolated from each other.

16. The image recognition system according to claim 1, wherein the optical isolation is effected by lithographically produced separating walls.

17. The image recognition system according to claim 1, wherein the detectors are present as at least one of: (i) a CCD, (ii) a CMOS photosensor array, and (iii) a photosensor array comprising a polymer.

18. The image recognition system according to claim 1, wherein at least a part of the microlenses is anamorphic.

19. The image recognition system according to claim 1, wherein the optical channels respectively have a plurality of detectors of one or more different functions.

20. The image recognition system according to claim 1, wherein pinhole diaphragms are disposed behind the microlenses and directly in front of the detectors and are positioned such that at least one pinhole diaphragm is assigned to each microlens.

21. The image recognition system according to claim 20, wherein the ratio of the active surface of the detector to the active surface area of the microlens is adjustable in order to fix light strength and resolution power through the pinhole diaphragm.

22. The image recognition system according to claim 20, wherein the pinhole diaphragms have a diameter in the range of about 1 to 10 μm.

23. The image recognition system according to claim 20, wherein the pinhole diaphragm is produced from a metal or polymer coating or combinations thereof.

24. The image recognition system according to claim 1, wherein the image recognition system has a liquid lens which is pre-connected between image and microlenses in order to adjust the field of view.

25. The image recognition system according to claim 1, wherein light sources are disposed on or between the optical channels.

26. The image recognition system according to claim 1, wherein a pixel is assigned to each optical channel.

27. The image recognition system according to claim 1, wherein a plurality of pixels is assigned to each optical channel.

28. The image recognition system according to claim 27, wherein a plurality of pixels with different properties or groups of pixels of the same properties are present.

29. The image recognition system according to claim 27, wherein colour filters are disposed in front of a plurality of similar pixels.

30. The image recognition system according to claim 27, wherein a plurality of similar pixels at a greater spacing is disposed in an optical channel in order to increase the light strength without loss of resolution.

31. The image recognition system according to claim 27, wherein a plurality of pixels per optical channel is disposed such that the optical axes of at least two optical channels intersect in one object spot in order to enable a stereoscopic 3D photograph and/or a distance measurement.

32. The image recognition system according to claim 27, wherein dispersive elements for colour photos are disposed in front of or on the microlenses.

33. The image recognition system according to claim 27, wherein differently orientated gratings or structured polarisation filters are disposed in front of similar pixels of an optical channel in order to adjust the polarisation sensitivity.

34. The image recognition system according to claim 1, wherein the image recognition system is combined with at least one liquid crystal element.

35. The image recognition system according to claim 1, wherein the image recognition system is an integral component in a flatly-constructed small appliance taken from the group of clocks, notebooks, PDAs or organisers, mobile telephones, spectacles or clothing items.

36. The image recognition system according to claim 1, wherein the image recognition system is operable for monitoring, security technology and for checking and implementing access or use authorisation.

37. The image recognition system according to claim 1, wherein the image recognition system is operable for integration in a camera in a chip card or credit card.

38. The image recognition system according to claim 1, wherein the image recognition system is operable for integration in equipment used for medical technology.

39. The image recognition system according to claim 1, wherein the image recognition system is operable for monitoring tasks in the interior and exterior of vehicles.

40. The image recognition system according to claim 1, wherein the image recognition system is operable for intelligent cockpit monitoring in the aircraft industry.

41. The image recognition system according to claim 1, wherein the image recognition system is operable for at least one of iris recognition, fingerprint recognition, object recognition and movement detection.
